(19) United States
(12) Patent Application Publication
(10) Pub. No.: US 2022/0032534 A1
(43) Pub. Date: Feb. 3, 2022

(54) APPARATUS FOR THE ADDITIVE MANUFACTURE OF A THREE-DIMENSIONAL WORKPIECE FROM A METAL MELT CONTAINING ALUMINUM

(71) Applicant: Robert Bosch GmbH, Stuttgart (DE)

(72) Inventors: Andreas Michalowski, Renningen (DE); Peter Voehringer, Kornwestheim (DE)

(21) Appl. No.: 17/413,610

(22) PCT Filed: Dec. 11, 2019
(86) PCT No.: PCT/EP2019/084587

§ 371 Date: Jun. 14, 2021

(30) Foreign Application Priority Data
Dec. 14, 2018 (DE) 10 2018 221 738.6

(51) Int. Cl. B29C 64/112; B29C 64/209; B22D 39/00; B33Y 10/00; B33Y 70/00

(52) U.S. Cl. CPC B29C 64/112; B29C 64/209; B33Y 70/00; B33Y 10/00; B22D 39/00

(57) ABSTRACT

The invention relates to an apparatus for the additive manufacture of a three-dimensional workpiece from a metal melt (1) containing aluminum, in particular an aluminum melt, comprising a compression chamber (2) which receives the metal melt (1) and is delimited by a piston (3) that is movable back and forth and by a nozzle body (4) having a nozzle bore (5) for discharging the metal melt (1) in drop form, wherein the nozzle body (4) has a metallophobic, in particular aluphobic structure (18), at least in the region (8) of a surface (7) adjoining the nozzle bore (5), which surface is arranged on the side facing away from the compression chamber (2),

### BACKGROUND OF THE INVENTION

The present invention relates to an apparatus for the additive manufacture of a three-dimensional workpiece from a metal melt containing aluminum, in particular an aluminum melt.

Additive manufacture comprises in particular 3D printing methods in which liquid or solid materials are built up in layers to form a three-dimensional workpiece. Liquid materials are applied to a workpiece substrate in the form of individual drops. Solid materials, for example in powder form, are melted locally. The present invention relates to a 3D printing apparatus which only uses liquid materials.

An apparatus for applying a fluid to a workpiece substrate in order to produce a workpiece is, for example, known from the document DE 10 2015 206 813 A1, which has a reservoir for holding the fluid and an outlet apparatus for discharging the fluid. The apparatus furthermore comprises an actuator device by means of which a volume of the reservoir can be reduced in order to produce a pressure wave. The pressure wave causes at least some of the fluid held in the reservoir to be discharged via the outlet device and applied to the workpiece substrate. For this purpose, the actuator device has a membrane which is formed in or as an outer wall of the reservoir and can be deformed elastically. The actuator device moreover comprises a movable piston by means of which the elastic deformation of the membrane can be effected when an eddy current actuator or a magnetic actuator is activated.

In order to increase the efficiency of such an apparatus, an increase in the drop frequency is often required. This means that the pressure waves or pressure pulses required to form the drops need to be generated at shorter intervals of time. This can cause cavitation areas and/or flow separation in the outlet device which affect the formation of the drops. In particular, a drop can be released prematurely with a diameter which additionally is smaller than the diameter of the discharge opening such that the drop is discharged excentrically and is deflected when it exits. This should be prevented.

### SUMMARY OF THE INVENTION

The object of the present invention is therefore to provide an apparatus for the additive manufacture of a three-dimensional workpiece from a metal melt containing aluminum, in particular an aluminum melt, which enables precise drop formation even at a high drop frequency.

In order to achieve the object, the apparatus according to the invention is proposed. Advantageous developments of the invention can be found in the dependent claims.

The proposed apparatus for the additive manufacture of a three-dimensional workpiece from a metal melt containing aluminum, in particular an aluminum melt, comprises a compression space which accommodates the metal melt and is delimited by a piston which can move back and forth and by a nozzle body with a nozzle bore for dispensing the metal melt in the form of drops.

The nozzle body here has, at least in the region of a surface which adjoins the nozzle bore and is arranged on the side remote from the compression space, a metallophobic, in particular aluminophobic structure. The metallophobic, in particular aluminophobic structure assists the rapid release of the drops at the end of the nozzle bore such that it is ensured that the drops are not deflected but travel straight to their destination.

The region is preferably formed from a porous structure. In further embodiments according to the invention, the region is formed from a needle- or stilt-shaped structure, wherein these are advantageously formed at a size of 1 to 10 μm.

By virtue of the embodiment according to the invention, it is advantageously achieved that a drop discharged from the nozzle bore does not experience any adhesive forces at all from the nozzle plate underside. The structure according to the invention results in a minimization of the contact of the liquid metal with the substrate and consequently, owing to the dominance of the cohesion forces, forces the liquid column to form drops.

It is moreover advantageous that the nozzle body is manufactured, at least in the region of the nozzle bore, from a metallophilic, in particular aluminophilic material or has a coating with a metallophilic, in particular aluminophilic material.

“Metallophilic” means that the contact angle between the metal melt and the surface formed from the metallophilic, in particular aluminophilic material is relatively small. The wetting of the surface with the metal melt is consequently improved. This has the advantage that the drops are released only at the end of the nozzle bore and not at an earlier stage inside the nozzle bore. It is thus possible to counter the premature release of drops. It is moreover ensured that the nozzle bore remains filled with metal melt after a drop has been produced so that as a result the next drop can be formed immediately. The process can thus be configured in a highly dynamic fashion and in particular the drop frequency can be increased. A drop frequency of 500 to 1000 Hz can, for example, be achieved without any of the disadvantages mentioned at the beginning occurring.

In the case of a nozzle bore which does not have an aluminophilic surface, the metal melt containing aluminum tends, owing to its high surface tension, to retreat after each pressure pulse for producing a drop from the nozzle bore. The nozzle bore therefore needs to be filled again with metal melt before a further drop can be produced. High drop frequencies cannot be obtained in this way. In addition, there is a risk that cavitation areas occur and/or flow separation and the associated disadvantages result. In particular, a smaller drop can be released inside the nozzle bore and be discharged excentrically from the nozzle bore, wherein the drop is deflected owing to the wall friction which is higher on one side.

These disadvantages can be overcome with the aid of the proposed apparatus which has a metallophobic, in particular aluminophobic structure in the region of a surface which adjoins the nozzle bore and is remote from the compression space, and has a metallophilic, in particular aluminophilic material in the region of the nozzle bore.

According to a preferred embodiment of the invention, the metallophilic, in particular aluminophilic material is silicon nitride. Silicon nitride has optimum properties with respect to metal melts containing aluminum for the intended area of application. In particular, the contact angle between the metal melt containing aluminum and the surface consisting of silicon nitride can be reduced.

The nozzle bore preferably has sections with bore diameters of different sizes, wherein the bore diameters preferably get smaller toward the end of the nozzle bore. The diminishing bore diameter assists the formation of drops and the release of the drops at the end of the nozzle bore. In order to optimize the flow inside the nozzle bore, it is proposed that the sections with different bore diameters are connected via a conically shaped section.

The nozzle body advantageously takes the form of a plate or comprises a nozzle plate. The plate form facilitates the formation of the nozzle bore because the region comprising the bore is easily accessible. If the nozzle body has a multi-part design and comprises a nozzle plate, the remaining parts of the nozzle body can be manufactured from a different material to the nozzle plate. The material can thus be matched to the respective function of a part of the nozzle body.

The nozzle body can, for example, comprise a hollow cylinder for radially delimiting the compression space. The hollow cylinder can thus also be used to guide the piston which can move back and forth. The hollow cylinder is therefore preferably manufactured from a material which is particularly wear-resistant.

If the nozzle body has a multi-part design and comprises a nozzle plate and a hollow cylinder, the nozzle plate and the hollow cylinder are preferably connected by means of a nozzle clamping nut. The two parts can be clamped to each other by means of the nozzle clamping nut. High sealing forces can be obtained by tensioning the two parts of the nozzle body such that it is ensured that no metal melt can escape to the outside between the two parts.

It is moreover proposed that the piston which can move back and forth of the apparatus is actively connected to an actuator, preferably to a magnetic or piezoelectric actuator. The piston can be moved back and forth with the aid of the actuator. A piezoelectric actuator is preferably used because it enables short rapid movements in order to produce pressure pulses in rapid succession.

### BRIEF DESCRIPTION OF THE DRAWINGS

The invention is explained in detail below with the aid of the attached drawings, in which:

FIG. 1 shows a schematic longitudinal section through an apparatus according to the invention,

FIG. 2 shows a schematic drawing of a metallophobic structure,

FIG. 3 shows a first exemplary embodiment of the metallophobic structure, and

FIG. 4 shows a second exemplary embodiment of the metallophobic structure.

### DETAILED DESCRIPTION

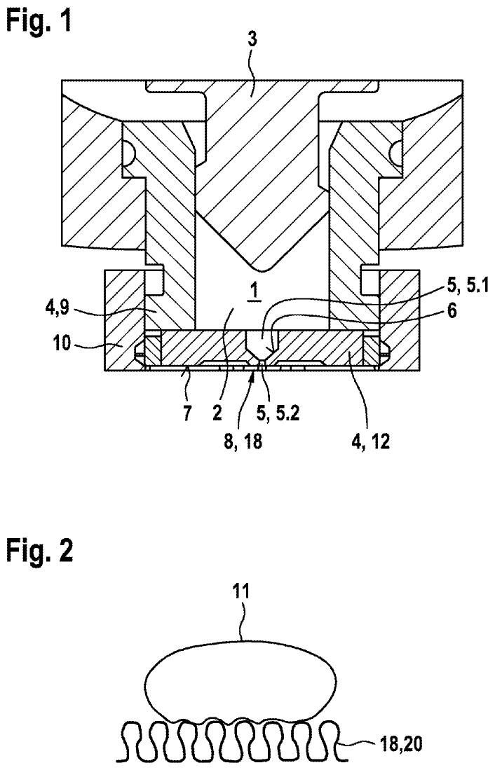

The apparatus according to the invention shown in FIG. 1 for the additive manufacture of a three-dimensional workpiece from a metal melt containing aluminum comprises a nozzle body 4 with a multi-part design which comprises a plate-shaped part and a nozzle plate 12. The nozzle plate 12 is connected, i.e. axially tensioned, to a hollow cylinder 9 by means of a nozzle clamping nut 10. A piston 3 which can move back and forth is accommodated in the cylinder 9. The piston 3, the hollow cylinder 9, and the nozzle plate 12 together delimit a compression space 2 which can be filled with a metal melt 1.

The apparatus moreover comprises an actuator (not shown) with the aid of which the piston 3 can be moved back and forth. The piston 3 is thus plunged into the compression space 2 or is retracted therefrom. In this way, pressure waves or pressure pulses are produced which press the metal melt 1 into a nozzle bore 5 of the nozzle plate 12 so that it is delivered through the nozzle bore 5 in the form of individual drops 11.

In order to ensure that the drops 11 are released in each case only at the end of the nozzle bore 5 and not at an earlier stage inside the nozzle bore 5, the nozzle plate 12 has a coating 6 of a metallophilic, in particular aluminophilic material in the region of the nozzle bore 5. The aluminophilic material improves the wettability of the surfaces adjoining the nozzle bore 5 with the metal melt 1 containing aluminum. The metal melt 1 thus has less tendency to retreat into the compression space 2 after a drop 11 has been produced such that the nozzle bore 5 remains filled with metal melt 1 and the next drop 11 can be formed immediately.

In the region 8 of a surface 7 which adjoins the nozzle bore 5 and is formed on that side of the nozzle plate 12 remote from the compression space 2, the surface 7 has a metallophobic, in particular aluminophobic structure 18. The aluminophobic structure 8 in turn assists the release of the drops 11 at the end of the nozzle bore 5, viewed in the flow direction of the metal melt 1. The surface 7 forms the nozzle plate underside 7.

In the apparatus shown in FIG. 1, the release of the drops 11 at the end is moreover promoted by the nozzle bore 5 formed in the nozzle plate 12 having sections 5.1, 5.2 with bore diameters of different sizes which are connected via a conically formed section 5.3. In this way, a nozzle bore 5 which tapers toward the end in the flow direction is created which assists the release of the drops 11 at the end.

With the aid of the apparatus shown in FIG. 1, drops 11 can thus be formed from a metal melt 1 containing aluminum which can have a defined size and be positioned precisely because they are not deflected after release and instead fall vertically downward.

FIG. 2 shows a schematic drawing of a metallophobic, in particular aluminophobic structure 18, wherein the structure 18 has a heterogenous surface texture 20 which favors the so-called lotus effect. The heterogenous surface texture 20 forms a porous structure 18 on which a drop 11 is formed.

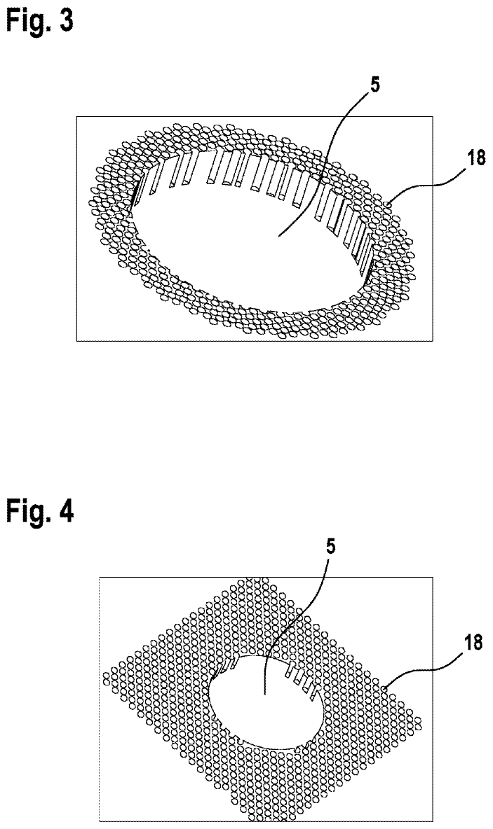

FIG. 3 shows a first exemplary embodiment of the metallophobic, in particular aluminophobic structure 18, wherein the structure 18 has a needle- or stilt-shaped design and is arranged annularly around the nozzle bore 5. The structure 18 takes the form of a flower structure.

FIG. 4 shows a second exemplary embodiment of the metallophobic, in particular aluminophobic structure 18, wherein the structure 18 has a needle- or stilt-shaped design and is arranged in a rectangle around the nozzle bore 5. The structure 18 takes the form of a checkerboard pattern.

The structures 18 according to the invention can be formed around the nozzle bore 5 by means of vaporizing or ablating ceramic material, for example using an ultrashort pulse laser (USP laser). The objective for all the exemplary embodiments is a heterogenous surface texture 20 which favors the so-called lotus effect.

Aluminophobic structures 18 with perforations of, for example, 10-20 μm are preferred for nozzle bores 5 with a diameter of preferably 300 to 500 μm. The relative spacing between the center points of the perforations is preferably of the same size. In order to obtain the structure 18 of the second exemplary embodiment in FIG. 4, for example when two loops are made which describe lines and columns around the perforation, a perforation needs to be introduced when the sum of lines and columns is an odd number. The perforations need to be introduced in the form of a Fibonacci spiral for the structure 18 of the first exemplary embodiment in FIG. 2.

The structure 18 needs to be attached for all exemplary embodiments only in the immediate surroundings of the nozzle bore 5 because it is only there that axially symmetrical separation of the drop might be adversely affected by the drop 11 being discharged adhering to the nozzle plate underside 7. The double to triple diameter of the nozzle bore 5 provides, for example, preferred coverage of the immediate surroundings of the nozzle bore 5.

1. An apparatus for the additive manufacture of a three-dimensional workpiece from a metal melt (1) containing aluminum, the apparatus comprising a compression space (2) which accommodates the metal melt (1) and is delimited by a piston (3) which can move back and forth and by a nozzle body (4) with a nozzle bore (5) for dispensing the metal melt (1) in the form of drops, characterized in that the nozzle body (4) has, at least in a region (8) of a surface (7) which adjoins the nozzle bore (5) and is arranged on a side remote from the compression space (2), a metallophobic structure (18).

2. The apparatus as claimed in claim 1, characterized in that the region (8) is formed from a porous structure (18).

3. The apparatus as claimed in claim 1, characterized in that the region (8) is formed from a needle-shaped structure (18).

4. The apparatus as claimed in claim 1, characterized in that the nozzle body (4) is manufactured, at least in the region of the nozzle bore (5), from a metallophilic material.

5. The apparatus as claimed in claim 1, characterized in that the nozzle body (4) takes the form of a plate.

6. The apparatus as claimed in claim 5, characterized in that the nozzle body (4) comprises a hollow cylinder (9) for radially delimiting the compression space (2).

7. The apparatus as claimed in claim 6, characterized in that the nozzle plate (12) and the hollow cylinder (9) are connected by a nozzle clamping nut (10).

8. The apparatus as claimed in claim 1, characterized in that the piston (3) is actively connected to an actuator.

9. The apparatus as claimed in claim 1, characterized in that the region (8) is formed from a stilt-shaped structure (18).

10. The apparatus as claimed in claim 1, characterized in that the nozzle body (4) has, at least in the region of the nozzle bore (5), a coating (6) with a metallophilic material.

11. The apparatus as claimed in claim 1, characterized in that the nozzle body (4) has, at least in the region of the nozzle bore (5), a coating (6) with an aluminophilic material.

12. The apparatus as claimed in claim 1, characterized in that the nozzle body (4) comprises a nozzle plate (12).

13. The apparatus as claimed in claim 1, characterized in that the nozzle body (4) is manufactured, at least in the region of the nozzle bore (5), from an aluminophilic material.

14. The apparatus as claimed in claim 1, characterized in that the piston (3) is actively connected to a magnetic or piezoelectric actuator.

15. An apparatus for the additive manufacture of a three-dimensional workpiece from a metal melt (1) containing an aluminum melt, the apparatus comprising a compression space (2) which accommodates the metal melt (1) and is delimited by a piston (3) which can move back and forth and by a nozzle body (4) with a nozzle bore (5) for dispensing the metal melt (1) in the form of drops, characterized in that the nozzle body (4) has, at least in a region (8) of a surface (7) which adjoins the nozzle bore (5) and is arranged on a side remote from the compression space (2), an aluminophobic structure (18).

16. The apparatus as claimed in claim 15, characterized in that the region (8) is formed from a porous structure (18).

17. The apparatus as claimed in claim 15, characterized in that the region (8) is formed from a needle-shaped structure (18).

18. The apparatus as claimed in claim 15, characterized in that the nozzle body (4) is manufactured, at least in the region of the nozzle bore (5), from a metallophilic material.

19. The apparatus as claimed in claim 15, characterized in that the nozzle body (4) has, at least in the region of the nozzle bore (5), a coating (6) with a metallophilic material.

20. The apparatus as claimed in claim 15, characterized in that the nozzle body (4) comprises a nozzle plate (12).
